(19) United States
(12) Patent Application Publication
(10) Pub. No.: US 2014/0036539 A1
(43) Pub. Date: Feb. 6, 2014

(54) DISPLAY HAVING A SEPARATE LIGHT SOURCE

(71) Applicant: SAMSUNG DISPLAY CO., LTD., Yongin-City (KR)

(72) Inventors: Jee-Na LEE, Suwon-si (KR); Sang Hwan Lee, Asan-si (KR); Myoung Hoon Song, Seoul (KR)

(73) Assignee: Samsung Display Co., Ltd., Yongin-City (KR)

(21) Appl. No.: 13/715,082

(22) Filed: Dec. 14, 2012

(30) Foreign Application Priority Data
Aug. 2, 2012 (KR) 10-2012-0084953

(51) Int. Cl. F21V 8/00

(52) U.S. Cl. CPC G02B 6/0011
USPC 362/613

(57) ABSTRACT

The present invention relates to a display device using a separate light source, and the display device includes: a light guide including a plurality of corners and a plurality of edges connecting the corners to each other; a printed circuit board (PCB) disposed at at least one of the plurality of corners of the light guide; at least one light source disposed on the PCB; a display panel overlapping the light guide; and an auxiliary function module disposed proximate to an edge of the light guide connected to the corner where the light source is disposed, wherein the edge of the light guide connected to the corner where the light source is disposed has a depressed portion, and the auxiliary function module is disposed in correspondence with the depressed portion.

### CROSS-REFERENCE TO RELATED APPLICATION

This application claims priority from and the benefit of Korean Patent Application No 10-2012-0084953, filed on Aug. 2, 2012, which is incorporated herein by reference for all purposes as if fully set forth herein.

### BACKGROUND OF THE INVENTION

1. Field of the Invention

Exemplary embodiments of the present invention relate to a display device such as a liquid crystal display which performs display using a separate light source.

2. Discussion of the Background

Display devices are classified as a self-emissive display device which displays an image by emitting light by itself and a passive display device which displays an image by is controlling the light emitted from a separate light source. A typical passive display device is a liquid crystal display.

Liquid crystal displays are now widely used as a type of a flat panel display. A liquid crystal display has two display panels on which field generating electrodes such as pixel electrodes and common electrodes are formed, a liquid crystal layer that is interposed between the panels, and a backlight module which provides light to one of the display panels. In the liquid crystal display, voltages are applied to the field generating electrodes so as to generate an electric field over the liquid crystal layer, and the alignment of liquid crystal molecules of the liquid crystal layer is determined by the electric field. Accordingly, the amount of the emitted light from the backlight module is controlled, thereby performing image display. The backlight module includes a light source which emits the light, a light guide which scatters the light from the light source to convert it into the planar light source, and various compensation films and scattering films.

Recently, with its various applications to portable devices, the liquid crystal display has been equipped with various components for additional or secondary functions, and a typical one of them may be a camera module or a communication antenna. However, such various components, such as a bezel, may increase the size of the liquid crystal display device which does not contribute to the actual display.

The above information disclosed in this Background section is only for enhancement of understanding of the background of the invention and therefore it may contain information that does not form the prior art that is already known in this country to a person of ordinary skill in the art.

### SUMMARY OF THE INVENTION

Exemplary embodiments of the present invention prevent an increase of a non-display unit of a display device even though an auxiliary functional component is added.

Exemplary embodiments of the present invention also simplify the display device by efficiently arranging each component of the display device.

A display device according to an exemplary embodiment of the present invention includes: a light guide including a plurality of corners and a plurality of edges connecting the corners to each other; a printed circuit board (PCB) disposed at at least one of the plurality of corners of the light guide; at least one light source disposed on the PCB; a display panel overlapping the light guide; and an auxiliary function module disposed proximate to an edge of the light guide connected to the corner where the light source is disposed, wherein the edge of the light guide connected to the corner where the light source is disposed has a depressed portion, and the auxiliary function module is disposed in correspondence with the depressed portion.

A display device according to another exemplary embodiment of the present invention includes: a light guide including a plurality of edges and a plurality of corners where the plurality of edges meet each other; a printed circuit board (PCB) disposed at at least one of the plurality of corners of the light guide; at least one light source disposed on the PCB; a display panel overlapping the light guide; a top chassis receiving the light guide, the PCB, and the display panel; and an auxiliary function module disposed outside the top chassis and proximate to an edge of the light guide extending from a corner where the light source is disposed, wherein the top chassis has a depressed portion, and the auxiliary function module is disposed at the depressed portion of the top chassis.

According to exemplary embodiments of the present invention, the auxiliary function component is disposed at the space generated from disposing the light source at the corner of the light guide such that the display device may be simplified.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a layout view of a liquid crystal display according to an exemplary embodiment of the present invention.

FIG. 2 is an exploded perspective view of a liquid crystal display according to an exemplary embodiment of the present invention.

FIG. 3 is a layout view of a backlight module of a liquid crystal display according to an exemplary embodiment of the present invention.

FIG. 4 is a cross-sectional side view of a liquid crystal display according to an exemplary embodiment of the present invention.

FIG. 5 is a layout view of a backlight module of a liquid crystal display according to another exemplary embodiment of the present invention.

FIG. 6 is a cross-sectional side view of a liquid crystal display according to another exemplary embodiment of the present invention.

FIG. 7 is a layout view of a liquid crystal display according to another exemplary embodiment of the present invention.

FIG. 8 is a layout view of a liquid crystal display according to another exemplary embodiment of the present invention.

### DETAILED DESCRIPTION OF THE ILLUSTRATED EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

Hereinafter, exemplary embodiments of the present invention will be explained in detail with reference to the accompanying drawings.

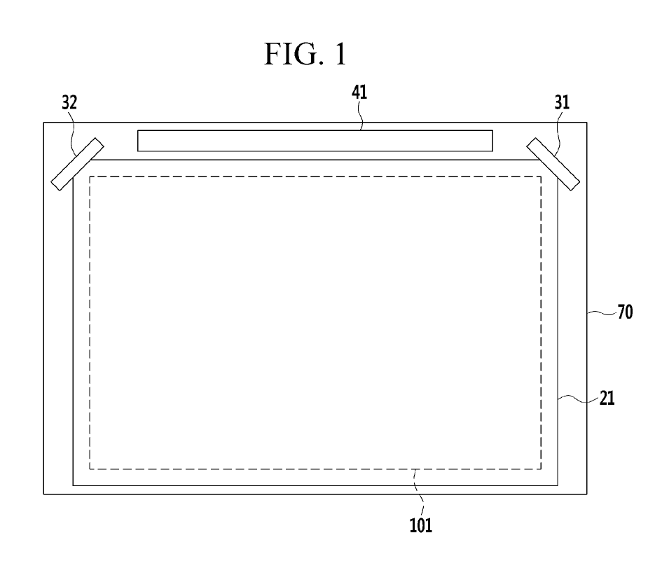

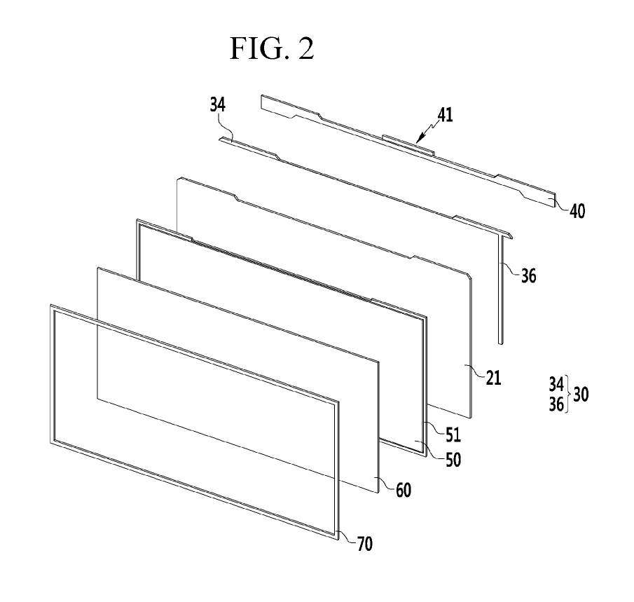

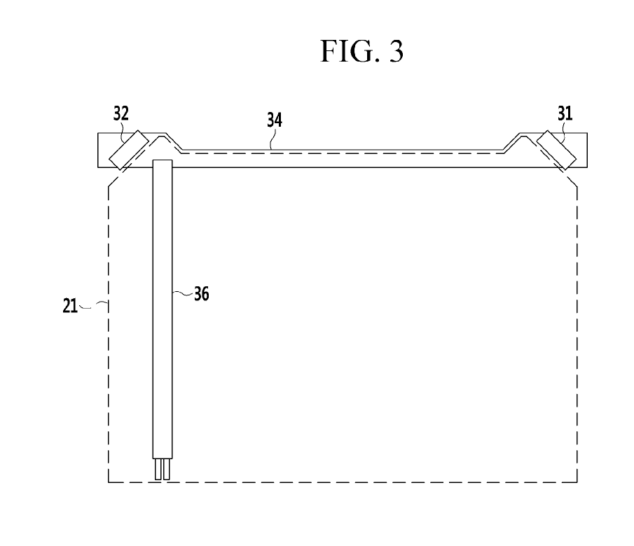

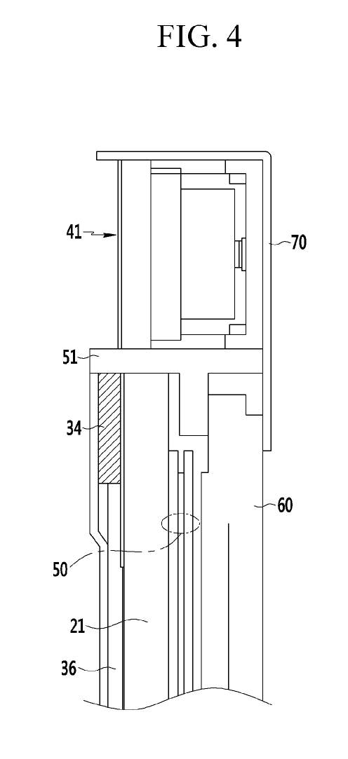

Firstly, referring to FIG. 1, FIG. 2, FIG. 3, and FIG. 4, a liquid crystal display according to an exemplary embodiment of the present invention will be described.

FIG. 1 is a layout view of a liquid crystal display according to an exemplary embodiment of the present invention, FIG. 2 is an exploded perspective view of a liquid crystal display according to an exemplary embodiment of the present invention, FIG. 3 is a layout view of a backlight module of a liquid crystal display according to an exemplary embodiment of the present invention, and FIG. 4 is a cross-sectional side view of a liquid crystal display according to an exemplary embodiment of the present invention.

A liquid crystal display according to an exemplary embodiment of the present invention includes a display panel 60, which includes two display panels (not shown) facing each other and a liquid crystal layer (not shown) interposed therebetween, and a backlight module which provides light to the display panel 60.

For simplification, FIG. 1 illustrates only light sources 31 and 32 and a light guide 21 forming a backlight module, an auxiliary function module 41 performing auxiliary functions such as a camera or an antenna, and a top chassis 70 receiving the backlight module, display panel, and the auxiliary function module 41, with reference to the display unit 101 that contributes to display of the image in the display panel.

The light sources 31 and 32 of the backlight module are disposed at two corners of the light guide 21 as shown in FIG. 1. Here, light emitting diodes (LEDs) may be used as the light sources 31 and 32. As described, if the light sources 31 and 32 are disposed at the corners of the light guide 21, an empty space is formed near the edge of the light guide 21 disposed between the two light sources 31 and 32. In such case, by disposing the auxiliary function module 41 at this space, the auxiliary function module 41 may be disposed without increasing the size of the liquid crystal display. The top chassis 70 may enclose the auxiliary function module 41 as well as the backlight module and the display panel.

Referring to FIG. 2, FIG. 3, and FIG. 4, the display panel 60, a frame 51 and various films 50, the light guide 21, a light source assembly 30, a back cover 40, and the auxiliary function module 41 disposed thereon are sequentially disposed, and the top chassis 70 is provided to enclose the various components. The various films 50 may include a scattering film and a compensation film, and the light source assembly 30 includes a printed circuit board (PCB) 34, the light sources 31 and 32 mounted thereon, and a flexible circuit film (FPC) 36 connecting the printed circuit board (PCB) 34 and a power source (not shown) and the display device controller (not shown). The center portion of the printed circuit board (PCB) 34 connecting the both ends of the printed circuit board (PCB) 34 where the light sources 31 and 32 are mounted is narrower in width than both ends, and the center portion is connected to lower parts of the both ends, thereby forming an empty space above the center portion. A portion of the light guide 21 corresponding to the center portion of the printed circuit board (PCB) 34 is depressed compared with a portion corresponding to both ends of the printed circuit board (PCB) 34 such that the empty space formed on the center portion of the printed circuit board (PCB) 34 is expanded over the light guide 21. The flexible circuit film 36 of the light source assembly 30 is connected to an end of the printed circuit board (PCB) 34 and is positioned at a side of the light guide 21 opposite to the side where the display panel 60 is disposed.

Referring to FIG. 3, the light guide 21 is generally rectangular, and two corners of the rectangle are cut to be chamfered. The light sources 31 and 32 are disposed at the chamfered portion of the light guide 21, and the edge of the light guide 21 connecting two chamfered corners is disposed proximate to the center portion of the printed circuit board (PCB) 34 and is depressed downward. In some cases, the light guide 21 need not be chamfered.

Referring to FIG. 4, the display panel 60 is disposed to be lower than the depressed portion of the light guide 21, and the light guide 21 and the display panel 60 are enclosed by the frame 51. The auxiliary function module 41 is disposed outside the frame 51, and the auxiliary function module 41 is separated by the frame 51 from the display panel 60 and the light guide 21. The top chassis 70 is disposed to cover the auxiliary function module 41 as well as the surroundings of the display panel 60.

As described above, the light sources 31 and 32 are disposed at the corners of the light guide 21, and the printed circuit board (PCB) 34 and the light guide 21 disposed between two light sources 31 and 32 are cut to form a space, and the auxiliary function module 41 is disposed in this space, thereby it is possible to dispose the auxiliary function module 41 without an increase of the size of the liquid crystal display.

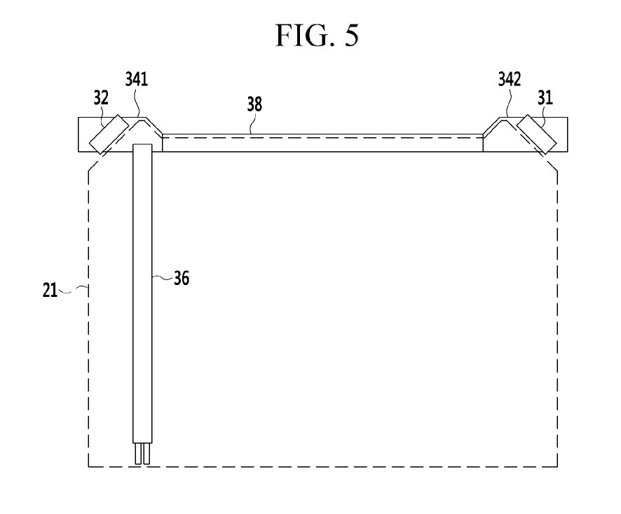

Another exemplary embodiment of the present invention will be described with reference to FIG. 5.

The exemplary embodiment of FIG. 5 is different from the exemplary embodiment of FIG. 1 to FIG. 4 in that printed circuit boards (PCB) 341 and 342 are separated from each other, and a flexible circuit film 38 connects them. The light sources 32 and 31 are respectively mounted on each of the printed circuit boards (PCB) 341 and 342, and the flexible circuit film 38 transmits power and electrical signals supplied to the printed circuit board (PCB) 342 through the flexible circuit film 38 and the printed circuit board (PCB) 341.

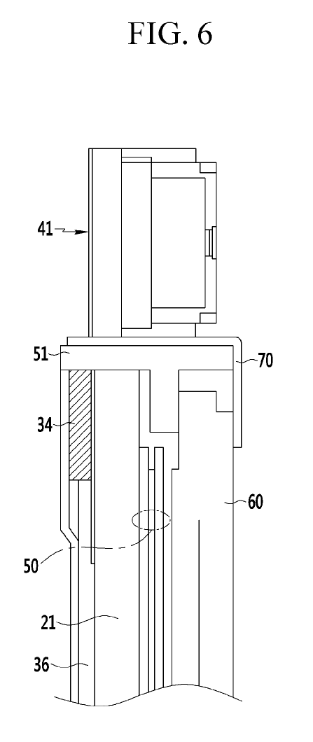

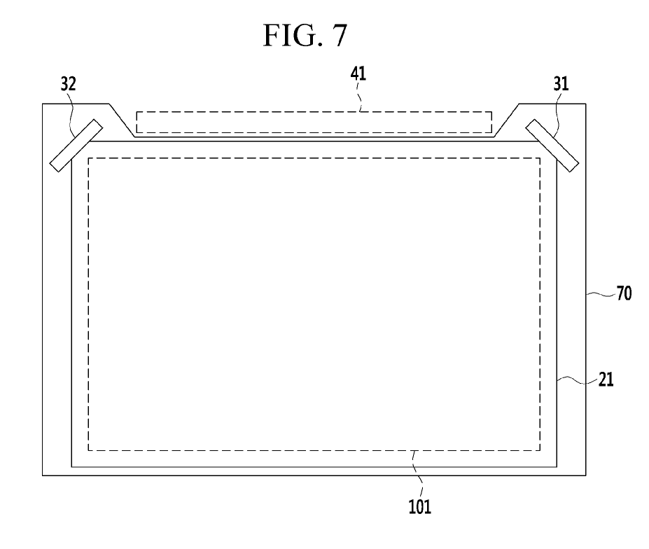

Another exemplary embodiment of the present invention will be described with reference to FIG. 6 and FIG. 7.

In the exemplary embodiment of FIG. 6 and FIG. 7, compared with the exemplary embodiment of FIG. 1 to FIG. 4, the auxiliary function module 41 is disposed outside the top chassis 70. For this arrangement, the upper surface of the top chassis 70 is partially depressed downward. The depressed portion of the top chassis 70 is disposed at the position corresponding to the portion where the printed circuit board (PCB) 34 and the light guide 21 are sunk. The auxiliary function module 41 is disposed at the depressed portion of the top chassis 70 such that the increase of the edge of the liquid crystal display to dispose the auxiliary function module 41 is prevented.

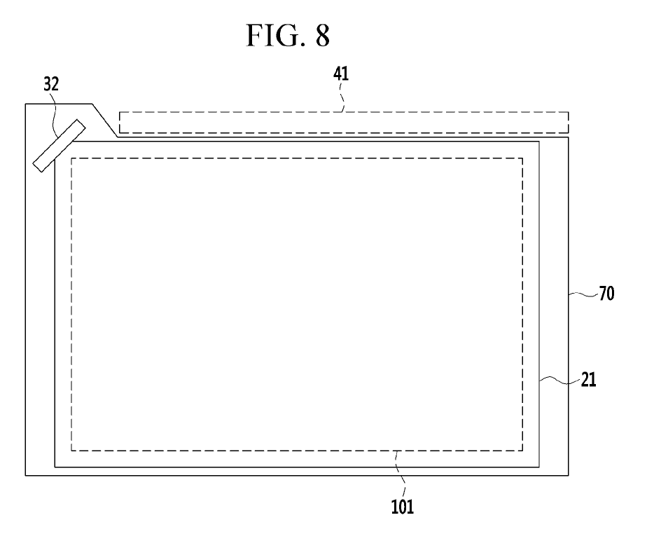

Another exemplary embodiment of the present invention will be described with reference to FIG. 8.

In the exemplary embodiment of FIG. 8, compared with the exemplary embodiment of FIG. 6 and FIG. 7, the light source 32 is only disposed at one corner of the light guide 21, and the depressed portion of the top chassis 70 is expanded to one side of the upper surface. This structure may be applied when the performance of the light emitting diode (LED) as used as the light source 32 is improved and a sufficient light amount may be available by one light source.

In the exemplary embodiment of FIG. 8, the auxiliary function module 41 is disposed outside the top chassis 70, however the auxiliary function module 41 may be disposed inside the top chassis 70. That is, in the exemplary embodiment of FIG. 1 to FIG. 4, one of two light sources 31 and 32 may be omitted.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A display device comprising:
a light guide comprising a plurality of corners and a plurality of edges connecting the corners to each other;
a printed circuit board (PCB) disposed at at least one of the plurality of corners of the light guide;
at least one light source disposed on the PCB;
a display panel overlapping the light guide; and
an auxiliary function module disposed proximate to an edge of the light guide connected to the corner where the light source is disposed,
wherein the edge of the light guide connected to the corner where the light source is disposed has a depressed portion, and the auxiliary function module is disposed in correspondence with the depressed portion.

2. The display device of claim 1, wherein
the light source comprises a first light source and a second light source respectively disposed on both ends of the PCB.

3. The display device of claim 2, wherein
a width of a center portion of the PCB is narrower than the width of both ends, and a space generated from the narrower center potion of the PCB overlaps the depressed portion of the light guide.

4. The display device of claim 3, further comprising
a top chassis enclosing the light guide, the display panel, the PCB, and the auxiliary function module.

5. The display device of claim 4, further comprising
a frame enclosing the light guide, the display panel, and the PCB and separating the auxiliary function module from the light guide, the display panel, and the PCB.

6. The display device of claim 1, wherein
the at least one light source comprises a first light source and a second light source, and
the PCB comprises a first PCB on which the first light source is disposed and a second PCB on which the second light source is disposed, and
further comprising a flexible circuit film connecting between the first PCB and the second PCB.

7. The display device of claim 6, wherein
the space generated from disposing the flexible circuit film overlaps the depressed portion of the light guide.

8. The display device of claim 7, further comprising
a top chassis enclosing the light guide, the display panel, the PCB, the flexible circuit film, and the auxiliary function module.

9. The display device of claim 8, further comprising
a frame enclosing the light guide, the display panel, the PCB, and the flexible circuit film and separating the auxiliary function module from the light guide, the display panel, the PCB, and the flexible circuit film.

10. The display device of claim 1, further comprising
a top chassis enclosing the light guide, the display panel, the PCB, and the auxiliary function module.

11. The display device of claim 1, wherein
the auxiliary function module comprises at least one of a camera module and an antenna module.

12. A display device comprising:
a light guide comprising a plurality of edges and a plurality of corners where the plurality of edges meet each other;
a printed circuit board (PCB) disposed at at least one of the plurality of corners of the light guide;
at least one light source disposed on the PCB;
a display panel overlapping the light guide;
a top chassis receiving the light guide, the PCB, and the display panel; and
an auxiliary function module disposed outside the top chassis and proximate to an edge of the light guide extending from a corner where the light source is disposed,
wherein the top chassis has a depressed portion, and the auxiliary function module is disposed at the depressed portion of the top chassis.

13. The display device of claim 12, wherein
the depressed portion is disposed at the edge of the light guide extending from the corner where the light source is disposed, and the depressed portion of the top chassis is disposed at the depressed portion of the light guide.

14. The display device of claim 13, wherein
the at least one light source comprises a first light source and a second light source respectively disposed on both ends of the PCB.

15. The display device of claim 14, wherein
a width of a center portion of the PCB is narrower than the width of both ends, and a space generated from decreasing the width of the center potion of the PCB overlaps the depressed portion of the light guide.

16. The display device of claim 13, wherein
the at least one light source comprises a first light source and a second light source, and
the PCB comprises a first PCB on which the first light source is disposed and a second PCB on which the second light source is disposed, and
the display device further comprises a flexible circuit film connecting between the first PCB and the second PCB.

17. The display device of claim 16, wherein
the space generated from disposing the flexible circuit film overlaps the depressed portion of the light guide.

18. The display device of claim 12, wherein
the auxiliary function module comprises at least one of a camera module and an antenna module.
